(19) United States
(12) Patent Application Publication
(10) Pub. No.: US 2021/0375505 A1
(43) Pub. Date: Dec. 2, 2021

(54) A TWISTED PAIR CABLE WITH A FLOATING SHIELD

(71) Applicant: COMMSCOPE TECHNOLOGIES LLC, Hickory, NC (US)

(72) Inventors: Douglas R. BRAKE, Denver, NC (US); Robert A. WESSELS, Jr., Hickory, NC (US); Wayne C. HOPKINSON, Hickory, NC (US)

(21) Appl. No.: 16/341,772

(22) PCT Filed: Oct. 13, 2017
(86) PCT No.: PCT/US2017/056525

§ 371 Date: Apr. 12, 2019

Related U.S. Application Data
(60) Provisional application No. 62/408,193, filed on Oct. 14, 2016.

(51) Int. Cl. H01B 11/08; H01B 7/02

(52) U.S. Cl. CPC H01B 11/08; H01B 3/441; H01B 7/0225

(57) ABSTRACT

A cable with a plurality of twisted pair wires arranged in a core. The cable also has a floating shield that surrounds the core. The floating shielding includes an electrically connective layer enclosed between inner and outer dielectric layers. The cable also includes a jacket that surrounds the floating shield.

### CROSS-REFERENCE TO RELATED APPLICATION

This application is being filed on Oct. 13, 2017 as a PCT International Patent Application and claims the benefit of U.S. Patent Application Ser. No. 62/408,193, filed on Oct. 14, 2016, the disclosure of which is incorporated herein by reference in its entirety.

### TECHNICAL FIELD

The present disclosure relates generally to cables for use in the telecommunications industry. More particularly, this disclosure relates to a multi-pair cable for use in the telecommunications industry.

### BACKGROUND

A wide variety of cable arrangements are utilized in the telecommunications industry. Such cable arrangements include twisted pair cables. Twisted pair cables include at least one pair of insulated conductors that are twisted about one another to form a twisted pair of conductors. A plurality of twisted pairs of conductors can sometimes twist about each other to define a twisted pair core. A polymeric jacket is typically extruded over a twisted pair core to maintain the configuration of the core and to function as a protective layer.

As twisted pairs are closely positioned in cables and the cables are positioned close together, electrical energy may be transferred between twisted pairs of adjacent cables. This type of cable-to-cable interference is commonly referred to as alien crosstalk. The telecommunications industry is continuously striving to increase the speed and/or volume of signal transmissions through the cables. One problem that concerns the telecommunications industry is the increased occurrence of alien crosstalk associated with high-speed signal transmissions. Therefore, the increase in signal frequencies associated with the high-speed transmissions requires improved alien crosstalk performance.

Category 6A cabling is required to satisfy more stringent alien crosstalk requirements than a typical installed category 6 channel. Category 6A systems are also specified to have less insertion loss in order to support positive signal-to-alien crosstalk margins over the frequency band required by the 10GBASE-T application. Compliant category 6A cabling products often attempt satisfy the alien crosstalk requirements by increasing diameters and mechanically isolating connectors by increasing the distance between them or via other means in patch panel and faceplates to reduce alien crosstalk. Category 6A cables also often rely on thicker and/or specially designed jackets to physically separate internal twisted-pairs from external twisted-pairs and ensure compliant alien crosstalk performance.

In some applications, to reduce the problem of alien crosstalk in a twisted pair cable, a layer of electrical shielding, that is configured to be readily grounded, is provided between the core of twisted conductors and the cable jacket. If a shielded cable is used to connect equipment from two different circuits, a ground loop can occur, causing noise on a network line. If the ground voltage difference is great enough it may even cause damage. Installers will often leave one end of the shielded cable terminated with a non-shielded connector, often referred to as a “floating” shield. Unfortunately, the floating shield often acts as an antenna that picks up additional noise.

### SUMMARY

The present disclosure relates generally to a cable with a plurality of twisted pair wires arranged in a core. The cable also has a floating shield that surrounds the core. The floating shielding includes an electrically connective layer enclosed between inner and outer dielectric layers. The cable also includes a jacket that surrounds the floating shield.

Another aspect of the present disclosure relates to a cable with a plurality of pairs of conductors extending in a core along a longitudinal axis and a non-terminating shield surrounding the plurality of pairs of conductors in the core. The shield has a conductive layer. The cable also has an outer jacket surrounding the non-terminating shield and defining the core. The outer jacket includes non-conductive material.

Another aspect of the present disclosure relates to a method for reducing alien crosstalk between cables. The method includes surrounding a plurality of twisted pair wires with a floating shield, and extending the floating shield within an outer jacket.

### BRIEF DESCRIPTION OF THE DRAWINGS

FIG. 1 is a cross-sectional illustration of a twisted pair cable, including a floating main shield, according to an example embodiment of the disclosure.

FIG. 2 is a cross-sectional illustration of a floating main shield according to an example embodiment of the disclosure.

### DESCRIPTION OF EXAMPLE EMBODIMENTS

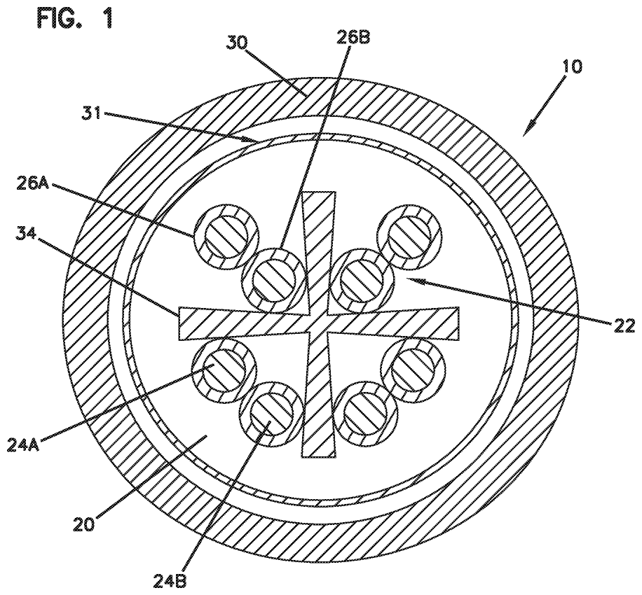

FIG. 1 is a cross-sectional view illustrating a twisted pair cable 10 according to the principles of the present disclosure. In the description that follows, the cable 10 will be described in terms of a data communication cable or the like. However, it is to be understood that the benefits described herein are also applicable to other types of cables. The following description is therefore provided for illustrative purposes only and is only one potential application of the subject matter of the present disclosure. In this disclosure, the term “conductive” is used to refer to electrical conductivity, and thus can be interchangeably used with “electrically conductive.”

Referring to FIG. 1, in general the twisted pair cable 10 includes a cable core 20, a jacket 30, and a floating main shield 31. The cable core 20 includes a plurality of twisted conductor pairs 22.

Each twisted conductor pair 22 includes two conductors 24A and 24B twisted about each other along a longitudinal axis of the pair. Example twisted conductor pairs are described in U.S. Pat. No. 5,814,768, filed on Dec. 11, 1996, and hereby incorporated by reference. The illustrated conductors 24A and 24B are surrounded by insulative layers 26A and 26B respectively. The insulative layers 26A, 26B can be referred to as dielectric layers. The conductors 24A and 24B may be fabricated from any conductive materials, such as, but not limited to, copper, aluminum, copper-clad steel, plated copper or the like. The conductors 24A and 24B can be solid or braided. The insulative layers 26A and 26B may be fabricated from any insulative, non-conductive materials, such as, but not limited to, polyvinyl chloride (PVC), polypropylene, a polymer, a fluoropolymer, a plastic, polyethylene, or the like.

Each of the conductors 24A and 24B of the individual twisted conductor pairs 22 can be twisted about one another at a continuously changing twist rate, an incremental twist rate, or a constant twist rate. Each of the twist rates of the twisted conductor pairs 22 can further be the same as the twist rates of some or all of the other twisted pairs 22, or different from each of the other twisted pairs 22.

Optionally, a divider can be used to segregate the twisted pairs 22 from each other along the longitudinal axis of the cable 10. An example divider 34 is illustrated to have four arms extending in an X or cross shape to form four quadrants. Each quadrant of the divider 34 contains one of the twisted pairs 22. Alternative types of dividers, for example tape spacers, can be similarly effective to segregate the twisted pairs 22 from each other. The divider 34 can be made of a non-conductive material such as polyvinyl chloride (PVC), for example. Other types of non-conductive materials can also be used for the divider 34, including other plastic materials such as fluoropolymers (e.g. ethylenechlorotrifluorothylene (ECTF) and flurothylenepropylene (FEP)), polyethylene, or other electrically insulating materials. Preferably, the material does not propagate flames or generate a significant amount of smoke.

The cable core 20 of the plurality of twisted pairs 22 can also be twisted about a longitudinal axis of the cable 10. The cable core 20 can be similarly twisted at any of a continuously changing, incremental, or constant twist rate.

The jacket 30 surrounds the cable core 20. In one embodiment, the jacket 30 is made of a non-conductive material such as polyvinyl chloride (PVC), for example. Other types of non-conductive materials can also be used for the jacket, including other plastic materials such as fluoropolymers (e.g. ethylenechlorotrifluorothylene (ECTF) and flurothylenepropylene (FEP)), polyethylene, or other electrically insulating materials. Preferably, the material does not propagate flames or generate a significant amount of smoke.

The cable 10 may further include the floating main shield 31. The floating main shield 31 is arranged within the jacket 30 and at least partially extends around the cable core 20, which includes the plurality of twisted pairs 22. In some embodiments, the floating main shield 31 is located on an inner side of the jacket 30. The floating main shield 31 can surround an entirety of the circumference of the cable core 20. In other embodiments, the floating main shield 31 can surround only a portion of the circumference of the core. The floating main shield 31 operates to shield the twisted conductor pairs 22 within the cable 10 from other cables.

The floating main shield 31 also operates to reduce an amount of alien crosstalk between different cables. In some examples, the floating main shield 31 includes electrically conductive metals, such as copper or aluminum. In other examples, the floating main shield 31 may be fabricated from any electrically conductive materials, such as, but not limited to, a laminated metal tape, an aluminum polyimide laminated tape, an aluminum biaxially-oriented polyethylene terephthalate (BoPET) laminated tape, a braid of conductive strands, metal or carbon/graphite fibers, a tube formed from a continuous (e.g., a sheet) conductive material (e.g., a sheet), and/or the like.

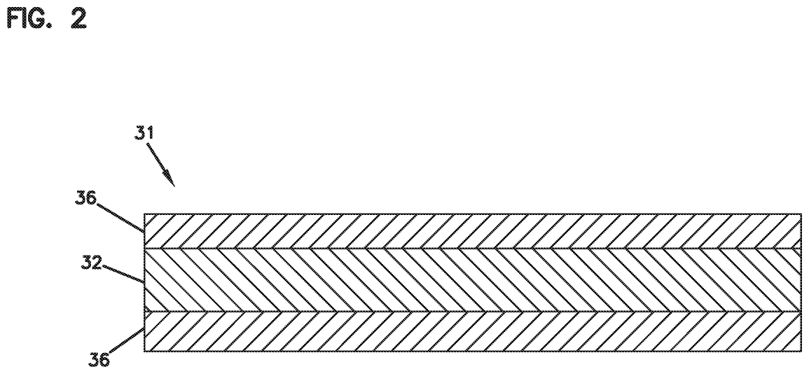

As illustrated in the cross-sectional view shown in FIG. 2, the floating main shield 31 includes a conductive layer 32 that is laminated on both (i.e., inner and outer) sides with an isolator layer 36. The inner and outer isolator layers 36 are made of a dielectric non-conductive material, such as polyester or a polyolefin. The conductive layer 32 is encased between the two isolator layers 36, so the floating main shield 31 cannot be readily terminated and grounded (i.e., floating shield). This floating main shield 31 allows the cable 10 to pass the alien crosstalk requirements of CAT 6A cable, while achieving a smaller diameter. In certain examples, the conductive layer is embedded within, contained within, encapsulated by, positioned between, enclosed between or fully enclosed by or between the dielectric insulation layers. In certain examples, the floating shield 31 is separate from the jacket 30 and is moveable relative to the jacket 30. In certain examples, the outer dielectric layer 36 is not integrated with, bonded to or incorporated as part of the jacket 30. In other examples, the outer dielectric layer 36 is a separate layer from the jacket 30 that optionally can be bonded to the jacket. In other examples, the outer dielectric layer 36 is not bonded to the jacket.

As used herein, a “floating” shield is a shield that is not grounded or is not intended to be grounded or otherwise electrically connected to another element or structure.

Other aspects of twisted pair cabling are also disclosed at PCT Publication WO/2015/200486, which is hereby incorporated by reference.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

We claim:

1. A cable comprising:
a plurality of twisted pair wires arranged in a core;
a floating shield that surrounds the core, the floating shield including an electrically conductive layer enclosed between inner and outer dielectric layers; and
a jacket that surrounds the floating shield.

2. The cable of claim 1, wherein the inner and outer dielectric layers of the floating shield comprise non-conductive material.

3. The cable of claim 1, wherein the floating shield is configured to reduce an amount of alien crosstalk between different cables.

4. The cable of claim 1, wherein the inner and outer dielectric layers are laminated to the electrically conductive layer.

5. The cable of claim 1, wherein the inner and outer dielectric layers are comprised of polyester or a polyolefin which cannot be terminated.

6. The cable of claim 1, wherein the inner and outer dielectric layers of the floating shield comprise laminated tape.

7. The cable of claim 1, further comprising a non-conductive divider to segregate the plurality of twisted pair wires within the core.

8. A cable comprising:
a plurality of pairs of conductors extending in a core along a longitudinal axis;
a non-terminating shield surrounding the plurality of pairs of conductors in the core, the shield comprising a conductive layer; and
an outer jacket surrounding the non-terminating shield and defining the core, the outer jacket comprising non-conductive material.

9. The cable of claim 8, wherein the plurality of pairs of conductors are pairs of twisted wires.

10. The cable of claim 8, wherein the non-terminating shield is a floating shield comprising a conductive layer encased between inner and outer isolator layers.

11. The cable of claim 8, wherein the non-terminating shield is a floating shield.

12. The cable of claim 8, wherein the non-terminating shield surrounds the core.

13. The cable of claim 8, wherein the non-terminating shield is movable relative to the outer jacket.

14. The cable of claim 8, wherein the non-terminating shield is bonded to the outer jacket.

15. The cable of claim 8, wherein the plurality of pairs of conductors are surrounded by dielectric layers.

16. A method for reducing alien crosstalk between cables, the method comprising surrounding a plurality of twisted pair wires with a floating shield, and extending the floating shield within an outer jacket.

17. The method of claim 16, wherein the floating shield comprises a conductive layer laminated by an insulative layer.
